(19) United States
(12) Patent Application Publication
(10) Pub. No.: US 2005/0214337 A1
(43) Pub. Date: Sep. 29, 2005

(54) Pesticidal compositions

(76) Inventors: Thomas McGee, New York, NY (US); Richard P. Sgaramella, Hoboken, NJ (US); Garry M. Johnson, Allendale, NJ (US)

Correspondence Address: NORRIS, MCLAUGHLIN & MARCUS, 875 THIRD AVE, 18TH FLOOR, NEW YORK, NY, 10022, US

(21) Appl. No.: 10/531,773

(22) PCT Filed: Oct. 16, 2003
(86) PCT No.: PCT/CH03/00677

§ 371 Date: Apr. 19, 2005

Related U.S. Application Data
(60) Provisional application No. 60/419,892, filed on Oct. 21, 2002.

(30) Foreign Application Priority Data
Feb. 26, 2002 (DE) 102-08-199.9

(51) Int. Cl. A01N 65/00; A01N 25/00

(52) U.S. Cl. 424/405; 424/725

(57) ABSTRACT

A composition for the controlled release of an essential oil having pesticidal or fungicidal activity comprises a carrier material for said essential oil and a component that controls the release of said essential oil from the carrier material.

This invention is concerned with compositions for controlling pests, microbes and fungi that affect the cultivation of ornamental and agricultural plants, crops and trees, and to methods of forming same.

There is considerable consumer interest in the provision of pesticides and fungicides that are capable of effectively controlling pests and diseases that afflict, for example ornamental and agricultural plants, crops and trees, and affect the storage of crops, fruits and seeds, but which are not regarded as harmful to mammals or the environment. One approach to environmentally friendly products is to use essential oils which are known to have pesticidal and/or fungicidal properties (see for example Gudrip Singh et al “Essential Oils: A potent source of natural pesticides”; Journal of Scientific & Industrial Research, 52, 676-683 (October 1993)).

Essential oils have been mixed with conventional inorganic or organic carrier materials of synthetic or natural origin such as talc, diamataceous earth, calcium phosphates, calcium and magnesium carbonates, flours, saw dust, corn cobs and tobacco stalks, and used in pesticidal or herbicidal applications in household or agricultural use (see, for example, International Publications WO 00/51436 or WO 01/10214). However, essential oils are volatile and display a propensity to evaporate rapidly and uncontrollably when simply absorbed on to carriers. Furthermore, for outdoor use, rain or irrigation water may easily wash the oils from conventional carriers.

Volatile oils used in flavour and fragrance applications have been encapsulated in polymer-coated particles for use in the consumer product, cosmetic, and food industries. However, having regard to the particular end uses of these products, such particles are adapted essentially to prevent release of the volatile oils until such time as they are exposed to exogenous stimuli such as dissolving media, e.g. water or aqueous media, or mechanical action generated by, for example chewing or rubbing of a composition onto skin, whereupon the particles provide the volatile oils to the user rapidly in a rushing or bursting manner.

There remains a need to provide compositions of volatile active materials, and in particular essential oils, for use in pesticidal or fungicidal applications that can release said active materials in a controlled manner over a prolonged period of time, in particular under conditions of elevated temperature and/or humidity that may be encountered in, for example agricultural use. Therefore, the invention provides in a first aspect a controlled release composition comprising an essential oil having pesticidal and/or fungicidal properties, a supporting material therefor and means for controlling the release of the essential oil from the supporting material.

Controlled release compositions (hereinafter “compositions”) of the present invention are useful for the release of essential oils or other volatile agents having pesticidal and/or fungicidal properties in a controlled manner and over prolonged periods of time. The essential oils are therefore released into the environment in a sensitive manner, that is, in controlled amounts such that the concentration in the environment is sufficiently high to treat the pest or disease state, but which does not reach levels that are excessive for the purpose intended. Further, the compositions may be made of relatively cheap raw materials and are of relatively simple construction.

Essential oils or other volatile active agents as hereinabove described are preferably substances having a vapour pressure greater than 1.10⁻⁴ mm Hg at 25° C., more preferably 1.10⁻³ mm Hg at 25 degrees centigrade. More preferably, the essential oils are materials that are non-toxic to mammals and the environment. By “essential oils” is meant volatile chemicals that may be the extracted essential oils from plants, or the active components of those oils, which have pesticidal and/or fungicidal activity. Representative examples include essential oils such as rosemary, thyme, lavender, eugenol, geranium, tea tree, clove, lemon grass, sweet flag root, woodruf, pyretrum flower, peppermint, garlic, cedar, mint, eucalyptus, jasmin, lavender, fennel, ginger, grapefruit, lemon, mandarin, orange, pine needle , tangerine, wintergreen, mustard seed, capsicum, pepper or their active components such as anethole, carvacrol, citonellal, citral, eugenol, linalool, 2,6-nonadienals, iso-eugenol, D-pulegone, carvone, alpha terpineol, cinnamic alcohol, cinnamic aldehyde, thymol, eucalyptol, farnesol, menthol, 1-carvone, limonene, pyrethrins, methyl salicylate, terpineol, beta asarone, methyl anthranilate, methyl salycylate, allyl isothiocynate, coumarine, propenyl propyl disulphide, camphor, nerolidol, geraniol, and mixtures thereof. The use of particular oils or components, or mixtures of same will depend upon the specific pest/fungus to be controlled and a person skilled in the art will have no problem in making appropriate selections.

In a first preferred embodiment of a composition according to the present invention, the supporting material may be a material, e.g. a powder material, that is capable of absorbing the essential oil to an extent that the resultant mixture is in the form of a free-flowing powder, and it may be selected from materials that include for example, clays; silicas; celites; zeolites; metal salts, including for example, phosphates; cellulose, such as methyl cellulose; starches; carbonates, such as sodium bicarbonate; borates, such as sodium borate; sulfates such as sodium sulfate; water soluble polymers; borax; and mixtures thereof.

The means for controlling the release of the essential oil from the supporting material (“controlling means”) as used in this first preferred embodiment may be a high molecular weight, low melting wax or solid that may be mixed readily with the support material. Examples of suitable controlling means for use in the present invention include polyethylene glycol, glycerol, mineral oil, and mixture thereof. The molecular weight of said controlling means in the present invention might vary between about 400 Daltons to about 20,000 Daltons, preferably between about 2,000 Daltons to 10,000 Daltons. Other controlling means having a similar viscosity and melting point to polyethylene glycol are also contemplated as useful in said first preferred embodiment.

In a preferred first embodiment, the composition comprises from 5 to 50% by weight of active agent; 0.2 to 10% by weight of controlling means; and 95 to 50% by weight of support material. Insofar as clays are employed as components of the support material, it is preferred that these clays be not present in amounts exceeding 50% by weight, more preferably not exceeding 15% by weight based on the total amount of support material. The amounts of each component may vary within these limits, provided that the resultant composition is in the form of a free-flowing powder, that is, a powder that is resistant to clumping or caking, and that may be easily poured from a container leaving essentially no residues in the container. Compositions may be considered to be free-flowing if 500 grams of the composition are placed into a one litre glass beaker and left overnight, and that all, or substantially all, of the composition, when the beaker is slowly tilted, is dispensed without having to mechanically dislodge it from the beaker. By “substantially all” is meant greater than 90% by weight is dispensed, more particularly greater than 95% is dispensed.

Preferably, the ratio of essential oil to support material is about 1:20 to about 1:1, more preferably about 1:5. The ratio of essential oil to controlling means is about 50:1 to about 2:1, more preferably about 20:1.

Said first preferred embodiment may be manufactured according to a process comprising the steps of mixing the active agent with the controlling means to form a premix, and mixing together the premix with the support material to form a free-flowing powder. Further details of a suitable process are set forth in the Example 1 below.

In a second preferred embodiment of a composition according to the present invention the composition is in the form of a capsule wherein the supporting material is provided as a core material and the means for controlling the release of the active agent from the supporting material (“controlling means”) is provided as a coating material coating said core material.

The coating material is preferably a water-insoluble polymeric material that may be useful in controlling the release of essential oil from the core material. Preferably the coating is formed from a suitable protein, carbohydrate or a synthetic polymer. More preferably a protein coating is employed in the present invention. Examples of suitable proteins include gelatin, albumin, casein or lacto-glogulin, and in particular gelatin. Any type of gelatin that may be employed in the manufacture of capsules for use in food, consumer product and medicinal fields may be employed in the present invention. However, a particularly preferred gelatin is 250 Bloom Type A gelatin. The coating material may additionally comprise other adjuvants useful in the manufacture of capsules, such as any of the carbohydrates, or synthetic polymers, e.g. polyvinylpyrollidone or methylcellulose commonly known and used in coating materials.

The coating may be crosslinked or not crosslinked. When employed, crosslinking agents include any of those crosslinking agents known and used in making capsules and gelatin-containing capsules in particular. They include formaldehyde or glutaraldehyde. Other known crosslinking agents include tannic acid, alum, or naturally occurring enzymes such as transglutaminase.

The core material may comprise an oil that may be selected from a wide range of oils having different chemical natures. The oils may be selected from mineral oils (petroleum or petroleum-derived), vegetable oils (e.g. from seeds and nuts) and animal oils, e.g. fats and fish oils. Preferably, the oil is selected from mineral, vegetable or benzyl alcohol. In a more preferred embodiment the oil is a short-chain triglyceride of fractionated coconut oil, available under the trade names Miglyol (Huls Corporation Piscataway N.J.), or Captex (Abitec Corp. Janesville Wis.).

The composition according to the second preferred embodiment may be in the form of a free-flowing powder within the meaning given to this term above, and may consist of particles having a mean diameter greater than 0.01 mm and less than 2 mm.

The composition of the second preferred embodiment may comprise 5 to 50% by weight of active agent, more particularly about 20% by weight.

The composition of the second preferred embodiment may be prepared by pre-forming a capsule comprising a coating surrounding an oil-containing core, and absorbing the active agent across the coating of the capsule into the core. This process may proceed according to a coacervation process as described in U.S. Pat. Nos. 6,106,875 and 6,045,835. Preferred capsules used in a process according to this methodology are commercially available under the Trade mark “Flavourburst”, Givaudan Flavours Corporation, Cincinnati, Ohio, USA.

Any of the compositions hereinabove defined may additionally comprise one or more optional auxiliary agents. As auxiliary agents there are mentioned any agent that imparts a benefit to said compositions. Such auxiliary agents may include, for example, flow aids, which ameliorate or eliminate caking or stickiness of the composition, e.g. hydrophobic silica and aluminosilicates; pigments; dyes; surfactants; emulsifiers; binders, e.g. starches, gums, glues, and mixtures thereof; enzyme inhibitors; antioxidants; pH modifier; fillers, e.g. cellulose, sand, soil, ground rock, fly ash, and mixtures thereof; and mixtures of any of the above.

Auxiliary ingredients aforementioned may be used in compositions in amounts of up to 50% by weight of the composition.

Compositions according to the present invention may be used alone in pesticidal and/or fungicidal applications, or they may be mixed with additional carrier material which may facilitate their application to the plant, seed, soil or other object to be treated, or improve storage, transport and/or handling of the composition. In general, any of the materials customarily employed in formulating pesticides or fungicides, are suitable. Suitable carrier materials include known inorganic or organic diluents or extenders of synthetic or natural origin, and may be selected from talc, attapulgite clay, kieselguhr, pyrophyllite, chalk, diatomaceous earth, vermiculite, calcium phosphates, calcium and magnesium carbonates, sulfur, flours, and other organic and inorganic solids which act as carriers for the pesticide and/or fungicides. Particularly preferred are particles of organic materials which are preferably biodegradable, e.g. ground corn cob, corn stalks, cherry pits, wood shavings, hulls of cereal grains, saw dust, coconut shells, tobacco stalks and ashes of organic matter and the like.

The composition and carrier material may be mixed such that the carrier material is present at 30% (wt) to 98% (wt) based on the total weight of the mixture.

The amount of composition used in pesticidal or fungicidal use will depend upon the particular condition to be treated, the nature of the environment (e.g. for use indoors or outdoors, e.g. in an agricultural field). Typically however, for agricultural use, it is contemplated that a kilogram quantity of composition containing 20% of essential oil may be mixed with a carrier material as aforementioned to treat an area of half an acre.

The composition according to the invention may be delivered in a multitude of ways. The composition may be contained in a sachet that allows egress of the essential oil, such that when the composition is placed in an environment, it will release the essential oil to the environment in a slow and controlled manner. Alternatively, the composition may be provided as a powder to be strewn over an area to be treated. Over relatively small areas compositions may be scattered by hand, although for large-scale agricultural operations, conventional techniques known in the art may be employed to distribute composition and carrier over large areas, for example spraying techniques.

Compositions according to the present invention deliver essential oil to an environment to be treated in a controlled and prolonged manner, that is, essential oil may be dispensed in a substantially uniform manner for periods 1 week or more depending upon the environmental conditions and the degree of infestation.

The following examples are provided to further illustrate the compositions and processes of the present invention. These examples are illustrative only and are not intended to limit the scope of the invention in any way.

### EXAMPLE 1

A composition is formed by combining the following components:

| Ingredient Type | Ingredient Name | %(w/w) |
|---|---|---|
| Active agent | Garlic Oil | 20 |
| Controlling | Polyethylene Glycol 4000 | 1 |
| means | | |
| Clay | Bentonite | 10 |
| Zeolite | VALFOR ™ 100 | 69 |

The garlic oil is mixed into the controlling means. The support material (i.e. clay and zeolite) are blended in a mixing vessel. Half of the liquid portion (i.e. garlic oil/controlling means mixture) is then added to the mixing vessel with stirring. The components are mixed until the liquid portion is well incorporated into the supporting material. Then, the rest of the liquid portion is mixed until the composition is in the form of a free flowing powder (composition 1).

10 grams of the composition 1 is added to 200 grams of corncob (OLOBLAST™ 14-40) and mixed well. The mixture is spread evenly over a plastic spray. A control is made by adding 2 grams of the garlic oil to 200 grams of corncob (OLOBLAST 14-40) and mixing well. The composition 1 and the control are split into two sets each and the sets are spread evenly on to plastic trays. The trays are placed in an outside environment but protected against rain. One set of each was left dry and the second set was sprayed with 20 grams of water daily and assessed after it had been left to dry for 4 hours. The sets were tested by 6 trained panellists for emission of the garlic oil over a period of 8 days. The results shown in the Tables below demonstrate that release of the garlic oil is perceptible from composition 1 in a substantially constant manner over a period of 8 days, whereas with the control sample, there is an initial strong emission of the volatile oil which tapers off quickly such that after only after 2 days, the intensity of the odour of the garlic oil is very low.

| | Sensory Evaluation Dry | | | | | |
|---|---|---|---|---|---|---|
| No water added | Results | | | | | |
| Sample | Day 1 | Day 2 | Day 3 | Day 4 | Day 5 | Day 8 |
| Control | 3.5 | 2.7 | 1.5 | 1.5 | 1.5 | 1.5 |
| Composition 1 | 5.0 | 5.0 | 5.0 | 5.0 | 4.5 | 4.0 |
| Water added | Sensory Evaluation Wetted Results | | | | | |
| Sample | Day 1 | Day 2 | Day 3 | Day 4 | Day 5 | Day 8 |
| Control | 2.5 | 2.5 | 1.5 | 1.5 | 1.5 | 1.4 |
| Composition 1 | 4 | 4.5 | 4.0 | 4.0 | 4.0 | 3.5 |

### EXAMPLE 2

The above experiment is repeated replacing the garlic oil with geraniol and using two carriers corncob (OLOBLAST 14-40) and Bentonite clay. The results below show that the composition 1 is providing a constant odour emission over 8 days. And the control odour emission drops off to a weak intensity.

| | Sensory Evaluation Dry | | | | | |
|---|---|---|---|---|---|---|
| No added water | Results | | | | | |
| Sample | Day 1 | Day 2 | Day 3 | Day 4 | Day 5 | Day 8 |
| Control | 3.0 | 2.4 | 1.5 | 1.4 | 1.2 | 1.2 |
| (corn cob) | | | | | | |
| Composition 1 | 4.0 | 4.3 | 4.0 | 4.0 | 4.0 | 3.6 |
| (Corn cob) | | | | | | |
| Control (Clay) | 3.0 | 2.3 | 1.4 | 1.4 | 1.0 | 1.0 |
| Composition | 4.5 | 4.5 | 4.5 | 4.5 | 4.0 | 3.3 |
| 1 (Clay) | | | | | | |

### EXAMPLE 3

Dry blank capsules are prepared according to the methodology set forth in the International Publication WO 99/17871. 70 parts blank capsules is placed in a 5-litre glass beaker and to the capsules are added garlic oil (20 parts), demineralised water (4 parts) and ethyl alcohol (6 parts). The resultant mixture is stirred on a magnetic stirrer for 2 minutes. Thereafter, the container is sealed and the mixture allowed to incubate for 24 hours to provide garlic oil-filled capsules (composition 2).

10 grams of the composition 2 is added to 200 grams of corncob (OLOBLAST 14-40) and mixed well. The mixture is separated into two sets and each set spread evenly over plastic trays. The composition 2 is thereafter compared as in Example 1 against sets of control sample.

| No Water | Sensory Evaluation Dry | | | | | |
|---|---|---|---|---|---|---|
| Added | Results | | | | | |
| Sample | Day 1 | Day 2 | Day 3 | Day 4 | Day 5 | Day 8 |
| Control | 3.5 | 2.7 | 1.5 | 1.5 | 1.5 | 1.5 |
| Composition 2 | 2.5 | 3.1 | 3.2 | 3.0 | 3.0 | 3.0 |
| Water | | | | | | |
| Sprayed on | Sensory Evaluation Wetted Results | | | | | |
| Sample | Day 1 | Day 2 | Day 3 | Day 4 | Day 5 | Day 8 |
| Control | 2.5 | 2.5 | 1.5 | 1.5 | 1.5 | 1.5 |
| Composition 2 | 3.0 | 3.1 | 3.3 | 3.2 | 3.0 | 2.6 |

The results shown in the Table above demonstrate that release of garlic oil is perceptible from composition 2 in a constant manner over a period of 8 days, whereas with the control sample, there is an initial strong emission of garlic oil which tapers off quickly such that after only 2 days, the odour of garlic is weak.

### EXAMPLE 4

The procedure as outlined in Example 3 is repeated with geraniol replacing garlic oil and using two carriers, viz. corncob (OLOBLAST 14-40) and Bentonite clay. The results are shown in the Table below.

| Water | | | | | | |
|---|---|---|---|---|---|---|
| Sprayed on | Sensory Evaluation Wetted Results | | | | | |
| Sample | Day 1 | Day 2 | Day 3 | Day 4 | Day 5 | Day 8 |
| Control | 2.5 | 2 | 1.5 | 1.4 | 1.0 | 1.0 |
| (Corn Cob) | | | | | | |
| Composition | 3.0 | 3.0 | 3.2 | 3.0 | 3.0 | 2.6 |
| 2 (Corn Cob) | | | | | | |
| Control (Clay) | 2.0 | 2.0 | 1.4 | 1.0 | 1.0 | 1.0 |
| Composition | 3 | 3.5 | 3 | 3 | 3 | 2.6 |
| 2 (Clay) | | | | | | |

The composition 2 maintains the intensity of the geraniol odour for at least 8 days, whereas the odour of the control system drops to very weak after 2 days.

1. A controlled release composition comprising an essential oil having pesticidal and/or fungicidal properties, a supporting material therefor and means for controlling the release of the active agent from the supporting material.

2. A composition according to claim 1 wherein the supporting material is a material capable of absorbing the essential oil to the extent that the resultant mixture is in the form of a free-flowing powder; and the means controlling the release of the essential oil from the supporting material is a high molecular weight, low melting point wax or solid that may be mixed readily with the support material.

3. A composition according to claim 2 wherein the support material is selected from the group consisting of clays; silicas; celites; zeolites; metal salts, including for example, phosphates; cellulose, such as methyl cellulose; starches; carbonates, such as sodium bicarbonate; borates, such as sodium borate; sulfates such as sodium sulfate; water soluble polymers; borax; and mixtures thereof.

4. A composition according to claim 3 wherein the means controlling the release of the essential oil from the supporting material is selected from polyethylene glycol, glycerol, mineral oil, and mixtures thereof.

5. A composition according to claim 1 in the form of capsules wherein the supporting material is a core material and the means controlling the release of the essential oil from the supporting material is a coating material coating said core material.

6. A composition according to claim 5 wherein the core material is an oil selected from mineral oils, vegetable oils, and animal oils.

7. A composition according to claim 5 wherein the coating material comprises a protein, carbohydrate or synthetic polymer.

8. A composition according to claim 7 wherein the coating material comprises gelatin.

9. Use of a composition as defined in claim 1 to deliver an essential oil having pesticidal or fungicidal activity to an environment in need of treatment.

10. A method of controlling the release of an essential oil having pesticidal or fungicidal activity into an environment in need of treatment comprising the step of applying a composition as defined in claim 1 onto an area to be treated.

11. A package containing a composition as defined in claim 1 said package containing instructions for use of the composition as a pesticide or fungicide.
